(19) United States
(12) Patent Application Publication
(10) Pub. No.: US 2008/0153065 A1
(43) Pub. Date: Jun. 26, 2008

(54) DEVICE FORMING PART OF A DENTAL SCREWING ARRANGEMENT

(75) Inventors: Izidor Brajnovic, Goteborg (SE); Roger Fromell, Nodinge (SE)

Correspondence Address: KNOBBE MARTENS OLSON & BEAR LLP, 2040 MAIN STREET, FOURTEENTH FLOOR, IRVINE, CA, 92614, US

(73) Assignee: Nobel Biocare AG, Glattbrugg (CH)

(21) Appl. No.: 12/014,031

(22) Filed: Jan. 14, 2008

Related U.S. Application Data
(63) Continuation of application No. 11/172,354, filed on Jun. 30, 2005, now abandoned.
Application No. 11/172,354 is a continuation of application No. PCT/SE03/01976, filed on Dec. 19, 2003.

(30) Foreign Application Priority Data
Dec. 30, 2002 (SE) 0203899-0

(51) Int. Cl. A61C 8/00

(52) U.S. Cl. 433/174

(57) ABSTRACT

A device which can be used in dentistry operates with two different screwing functions. The functions can be performed with the aid of at least three different types of screwing tools. With a first screwing function, first and second components are held together, and, with the second screwing function, the held-together components are screwed, for example, into the jaw bone in which one component is to be anchored. The first function operates with a Unigrip function, whose screw head is situated inside the first component. The second function operates with an internal Stargrip function and an external hexagon function on the first component. The screw of the first function, with its associated screw head, can be applied insider the first component via a portion forming the Stargrip function.

### PRIORITY INFORMATION

This application is a continuation of U.S. patent application Ser. No. 11/172,354, filed Jun. 30, 2005, which is a continuation of International Application PCT/SE2003/001976, with an international filing date of Dec. 19, 2003, which claims priority under 35 U.S.C. § 119 to Swedish Patent Application No. SE 0203899-0, filed Dec. 30, 2002, the entire contents of each of which are expressly incorporated by reference herein.

### BACKGROUND OF THE INVENTION

1. Field of the Invention

The present invention relates to a device forming part of a dental screwing arrangement.

2. Description of the Related Art and Summary of the Invention

Embodiments of the present invention can be used advantageously in conjunction with the installation principles proposed by Nobel Biocare AB and going under the name ARK (Absolute Rehabilitation Kit). Reference is made, inter alia, to PCT applications WO 02/053055 A1, WO 02/053056 A1 and WO 02/053057 A1 filed by the same Applicant and same inventor as for the present patent application. Said specifications relate to said principles. However, the invention has a more general use in dental installation arrangements in conjunction with tooth replacement structures for individual teeth, dental bridges for two or more teeth, etc., and templates and accessories therefor.

Embodiments of the present invention use, inter alia, the terms Stargrip function and Unigrip function, in which connection reference is made to the fact that these terms are known in the dental field in connection with the ranges sold by Nobel Biocare AB. See, inter alia, patents obtained and patent applications filed by the same Applicant. Thus, for example, the Stargrip function is a “star screw function” combined with a securing function which operates with a wedging principle, by which the tool can be connected to a screw or component and brought with the securing function to the thread mouth in question. The Unigrip function permits the application of a general use of the tool in question.

Advances are constantly being made in the dental field in question here and it is therefore important in some situations to use configurations for screwing functions which can be exchanged for older configurations, for example square configurations, with more modem and effective configurations. An aim of certain embodiments of the invention is to solve these problems, among others.

The components used and screwing functions are to be able to be effected with a varying and greater number of tools which are made available and have been made available on the market by Nobel Biocare AB. Certain embodiments of the invention aim to solve this problem too.

Accordingly, one embodiment of the present invention relates to a device forming part of a dental screwing arrangement which operates with at least two different screwing functions that can be performed by at least three different types of screwing tools. The first screwing function is intended for holding together first and second components, and the second screwing function is intended for screwing the components held together by the first screwing function.

Another embodiment of the present invention comprises which can a device that comprises, inter alia, that a first screwing function operates with a Unigrip function, whose screw head is situated inside the first component, and that a second screwing function operates with an internal Stargrip function and an external hexagon function on the first component. Further characteristics are that the screw of the first screwing function, with said screw head, can be applied in its position inside the first component via a portion forming the Stargrip function.

In a preferred embodiment, the first component comprises a fixture holder and the second component comprises a fixture designed to be applied in a jaw bone with the aid of the fixture holder and an installation arrangement with template provided with a guide member, for example a guide sleeve, via which the fixture and the fixture holder in the assembled state or position can be applied to the jaw bone so that the fixture can be screwed down into the jaw bone with the second screwing function.

Further developments of the concept of the invention are set out in the attached dependent claims.

By what has been proposed above, efficient installation possibilities are obtained in which older configurations can be rationalized and replaced with more modern configurations. The components are designed so that they can be used with existing tools and tools with different functions. Thus, the subject of the invention can satisfy the modern solutions used generally in Nobel Biocare AB's presently available articles. For example, screwdrivers with slots can be replaced by the Unigrip function. The fixture holder or equivalent component which previously had a square drive head can now be arranged for Stargrip function WP. In addition, a hexagonal outer shape is used which can serve to tighten or screw the fixture with a manual torque wrench when the machine concerned does not have the power to perform tightening. The outer hexagonal shape can also serve as contraindicator when the fixture holder is to be released from the installed fixture. If there is lack of space, a tool with a so-called open-end wrench function can also be used because the hexagonal part is arranged with undercuts.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A presently proposed embodiment of the invention will be described below with reference to the attached drawing, in which:

FIG. 1 shows a longitudinal section through first and second components in the form of a fixture and a fixture holder arranged in a jaw bone with the aid of installation equipment comprising a template with guide sleeve.

### DETAILED DESCRIPTION OF THE PREFERRED EMBODIMENT

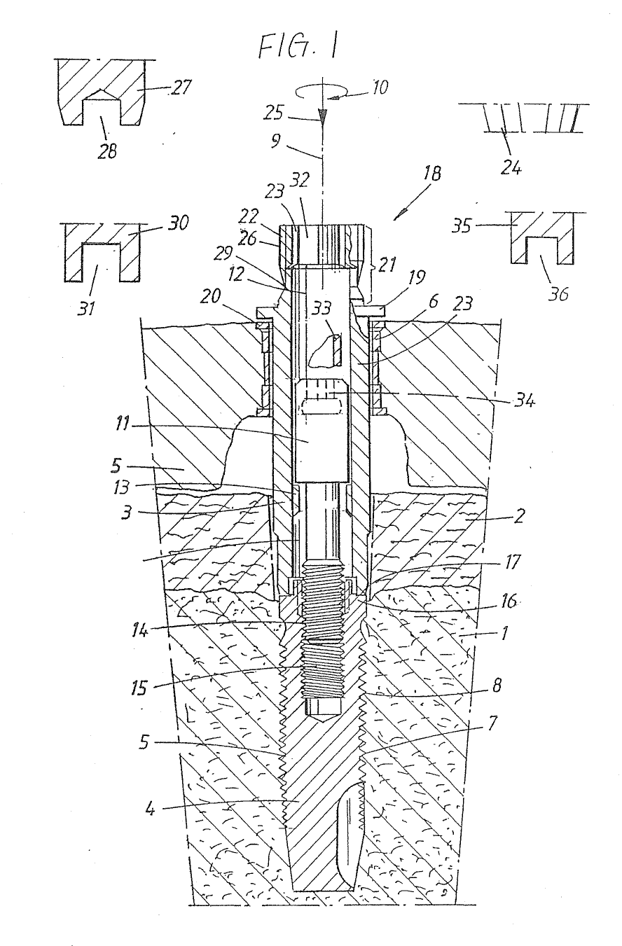

In the FIG. 1, reference number 1 designates a jaw bone, and reference number 2 designates gum or soft tissue. A first component in the form of a fixture holder is designated by 3, and a second component in the form of a fixture is designated by 4. In accordance with what is described below, the fixture and the fixture holder are held together as one unit which can be applied in the jaw bone via a template 5. The template comprises a sleeve 6 through which the assembled unit with the fixture 4 can be driven down to cooperate with the jaw bone, for example into a hole 7 formed in the latter, in which hole 7 the fixture 4 is to be screwed via a thread 8 arranged on the outside of the fixture. The assembled unit is screwed by rotating the unit about its longitudinal axis 9 in a direction of rotation 10.

The fixture and the fixture holder are held together with a first screwing function comprising a screw 11 arranged inside a space 12 inside the first component or the fixture holder. The screw has a screw head which can be applied against an inwardly directed flange 13 arranged in the fixture holder. The screw 11 extends with a threaded part 14 down into the inner thread 15 in the fixture. Said threaded part has an outer thread which can cooperate with the inner thread. The fixture has an upper surface 16 against which the end surface 17 of the fixture holder can be applied in said assembled position. The arrangement with first and second components in the form of a fixture holder and a fixture thus held together by a screw function is already known per se, and in this connection reference may be made inter alia to said PCT applications.

The assembled unit has a second screwing function indicated symbolically by 18. The height position of the assembled unit can be determined by means of a stop member, for example an outwardly protruding flange 19, on the outside of the fixture holder, which stop member cooperates with a corresponding stop member 20 on the sleeve 6. Thus, the underside of the flange 19 comes to lie against an upper surface of the flange 20. The first component or the fixture holder is provided with a part 21 which extends above the stop member 19 and which, in the illustrative embodiment, is situated outside or above the template 5. The part 21 can have an upper or outer portion 22 which on the inside has a Stargrip function 23. This Stargrip function can permit cooperation with a tool which is designed with a corresponding Stargrip function in a manner known per se. In the figure, such as tool is indicated symbolically by 24. The tool can be applied from above and driven toward the Stargrip function 23 in a direction 25 in a manner known per se. The portion 22 is provided on its outside 26 with a hexagonal shape of a type known per se. Such a tool is indicated symbolically in the figure by 27, and the tool's recess is indicated by 28. This tool too is known per se and the recess 28 will of course be of a size which allows it to be attached to the outer hexagon 26. Below the portion 22, a wrench grip 29 can also be provided in a manner known per se. The tool 27 can consist of or comprise a manual torque wrench. Alternatively, an open-end wrench function can be used, which has been represented by 30 in the figure. When using the tool 30, its recess 31 is engaged over the portion 22, which in a manner known per se is designed with undercuts.

The screw 11 can first be applied with its front end down into the recess 12 via the Stargrip function 23, i.e. via its recess 32, so that the screw with screw head and threaded part can be pushed down into the recess in the direction 25 to the position shown in the figure. A tool 33 can also be applied via the recess 32 in order to cooperate with the screw head 11 with Unigrip function 34. The unit 3, 4 in the assembled state, i.e. a state which has been produced with the first screwing function with the screw 11, is applied to the jaw bone where the fixture is screwed tight. The first screwing function has thus been activated before full insertion. The tool can also be applied to the screw head and Unigrip function 34 when the fixture holder is to be released from the installed fixture. This loosening function takes place in a direction of rotation counter to the direction of rotation 10. The hexagon shape 26 or wrench grip shape 29 can be used as supports in this case. The tool which can cooperate with the wrench grip 29 is indicated symbolically by 35 in the figure, and the actual recess part in the tool by 36. Since tool functions of a type known per se can be used to perform the different tightening functions can be used, they will not be described in detail here, and instead reference is made in purely general terms to the range offered for sale by Nobel Biocare AB. The anchoring principle for the fixture 4 with the aid of fixture holder 3 and template 5 is already known and will therefore not be described in detail here, and instead reference may be made inter alia to the patent applications mentioned above.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the invention is not limited to the embodiment shown above by way of example, and instead it can be modified within the scope of the attached patent claims and the inventive concept.

What is claimed is:

1. A device that forms part of a dental screwing arrangement which operates with at least two different screwing functions that can be performed by at least three different types of screwing tools, the first screwing function is configured to hold together first and second components, and the second screwing function is configured to secure the first and second components held together by the first screwing function, wherein the first screwing function operates with a Unigrip function, whose screw head is situated inside the first component, and the second screwing function operates with an internal Stargrip function and an external hexagon function on the first component, and in that a screw of the first screwing function, with said screw head, can be applied in its position inside the first component via a portion forming in the Stargrip function.

2. The device as in claim 1, wherein the first component comprises a fixture holder and the second component comprises a fixture designed to be applied in a jaw bone with the aid of the fixture holder and an installation arrangement with template provided with a guide member via which the fixture and the fixture holder in the assembled state is obtained by a retaining screw which performs the first screwing function, can be applied so that the fixture can be screwed down into the jaw bone with the second screwing function.

3. The device as in claim 2, wherein the guide member comprises a guide sleeve.

4. The device as claim 2, comprising a screw tightener that is configured to perform the first screwing function by via the screw inside the first and second components and in which the screw is driven down into the inside of the first component via the portion forming the Stargrip function.

5. The device as in claim 2, wherein in that the portion forming the Stargrip function is arranged on a part located outside the guide member of the template.

6. The device as in claim 5, wherein the part located outside the guide member has, on its outside, the external hexagon function by which the first component can be activated with a tool using the hexagon function.

7. The device as in claim 6, wherein in that the tool comprises of a manual torque wrench.

8. The device as in claim 7, wherein the tool comprises an open-end wrench.

9. The device as in claim 8, wherein the portion is arranged on the inner parts of the outwardly protruding part, and the hexagon function is arranged on the outside of the outwardly protruding part.

10. The device as in claim 1, wherein the hexagon function is arranged as contraindication on loosening of the first component or the fixture holder from the second component when the latter is in its installed state.

11. The device as in claim 10, wherein in that the loosening can be effected when the second component has the form of a fixture installed in the jaw bone.
